(19) United States
(12) Patent Application Publication
(10) Pub. No.: US 2017/0114764 A1
(43) Pub. Date: Apr. 27, 2017

(54) FUEL INJECTION VALVE

(71) Applicant: KEIHIN CORPORATION, TOKYO (JP)

(72) Inventor: Takuya HONJO, SHIOYA-GUN (JP)

(21) Appl. No.: 15/399,501

(22) Filed: Jan. 5, 2017

Related U.S. Application Data
(63) Continuation of application No. 14/377,572, filed on Aug. 8, 2014.

(30) Foreign Application Priority Data
Feb. 13, 2012 (JP) 2012-028816

(51) Int. Cl. F02M 61/04; F02M 61/20; F02M 51/06

(52) U.S. Cl. CPC F02M 61/045; F02M 51/0671; F02M 61/205

(57) ABSTRACT

A fuel injection valve includes a fixed core formed into a cylindrical shape, a valve plunger that can move closer to or away from the fixed core, a retainer formed with a substantially C-shaped cross-section having one long straight opening extending linearly along the entire length in an axial direction while having a tapered face on an outer periphery of each of opposite end parts in the axial direction and is press fitted into the fixed core, and a return spring provided between the retainer and the valve plunger. A cutout is provided in peripherally opposite end parts of the retainer for increasing the width between opposite end parts in a longitudinal direction of the opening. This enables the degree of freedom in selecting the material for forming a retainer while preventing the occurrence of galling or generation of swarf when press fitting the retainer into the fixed core.

### CROSS-REFERENCE TO RELATED APPLICATIONS

This application is a continuation application of the U.S. patent application Ser. No. 14/377,572, filed on Aug. 8, 2014, which is US National Phase of International Application No. PCT/JP2013/050053, filed on Jan. 8, 2013, and which claims priority from the Japanese Patent Application No. 2012-028816, filed on Feb. 13, 2012. The entire contents of these prior applications are incorporated herein by reference.

### TECHNICAL FIELD

The present invention relates to a fuel injection valve that includes a fixed core that is formed into a cylindrical shape from a magnetic metal, a valve plunger that is coaxially disposed so as to oppose one end of the fixed core and can move closer to or away from the fixed core, a retainer that is formed with a substantially C-shaped cross-section having one long straight opening extending linearly along an entire length in an axial direction while having a tapered face on an outer periphery of each of opposite end parts in the axial direction and is press fitted into the fixed core, and a coil-shaped return spring that is provided between the retainer and the valve plunger.

### BACKGROUND ART

A fuel injection valve in which, when a retainer with a substantially C-shaped cross-section is press fitted into a cylindrical fixed core, in order to prevent fine swarf from being generated by an outer peripheral face of the retainer being scraped by an inner peripheral face of the fixed core, a tapered face is formed on outer peripheries of opposite end parts in the axial direction of the retainer is already known from Patent Document 1.

### RELATED ART DOCUMENTS

### Patent Documents

Patent Document 1: Japanese Patent Application Laid-open No. 2003-314399

### DISCLOSURE OF INVENTION

Problems to be Solved by the Invention

A retainer with a substantially C-shaped cross-section having tapered faces on outer peripheries of opposite end parts in the axial direction is usually formed by rounding, by means of a roller, a flat plate-shaped material having preformed inclined faces in order to form the tapered faces, but in this process the material has a region that is easily stretched and a region that is difficult to stretch, and the angle of the tapered face after rounding is sometimes non-uniform in the peripheral direction of the retainer; in particular, warping easily occurs in peripherally opposite end parts sandwiching the opening of the retainer, and even if tapered faces are formed on outer peripheries of opposite end parts in the axial direction of the retainer, galling or swarf generation might be caused when press fitting the retainer into the fixed core. Moreover, depending on the material from which the retainer is formed, since pressure and material elongation during rounding vary, there is a change in angle of the tapered face that varies depending on the material, and the degree of freedom in selecting the material becomes limited.

The present invention has been accomplished in light of such circumstances, and it is an object thereof to provide a fuel injection valve that enables the degree of freedom in selecting the material for forming a retainer to be ensured while preventing the occurrence of galling or the generation of swarf when press fitting the retainer into a fixed core.

### Means for Solving the Problems

In order to attain the above object, according to a first aspect of the present invention, there is provided a fuel injection valve comprising a fixed core that is formed into a cylindrical shape from a magnetic metal, a valve plunger that is coaxially disposed so as to oppose one end of the fixed core and can move closer to or away from the fixed core, a retainer that is formed with a substantially C-shaped cross-section having one long straight opening extending linearly along an entire length in an axial direction while having a tapered face on an outer periphery of each of opposite end parts in the axial direction and is press fitted into the fixed core, and a coil-shaped return spring that is provided between the retainer and the valve plunger, characterized in that a cutout or a chamfered part is provided in peripherally opposite end parts of the retainer so as to increase a width between opposite end parts in a longitudinal direction of the opening.

Further, according to a second aspect of the present invention, in addition to the first aspect, a second cutout is provided in a middle part in the peripheral direction of the retainer in a section opposing the opposite end parts in the longitudinal direction of the opening.

### Effects of the Invention

In accordance with the first aspect of the present invention, since the cutouts or chamfered parts are provided in opposite end parts in the peripheral direction of the retainer so as to widen the opposite end parts in the longitudinal direction of the opening, a region in which warping easily occurs during rounding due to the presence of the opening can be removed, thereby preventing the occurrence of galling or the generation of swarf when press fitting the retainer into the fixed core. Moreover, since the structure merely involves providing the cutouts or chamfered parts, and the material for forming the retainer is not limited, the degree of freedom in selecting the material can be ensured.

Furthermore, in accordance with the second aspect of the present invention, a change in angle of the tapered faces in a middle part in the peripheral direction of the retainer easily occurs during rounding, but because the section in which the change in angle easily occurs is removed by the second cutouts, the angle of the tapered faces can be made uniform in the peripheral direction, and this makes it unnecessary to carry out an operation of correcting the angle of the tapered faces, thus reducing the number of steps and reducing the cost while more reliably preventing the occurrence of galling or the generation of swarf when press fitting the retainer into the fixed core.

### BRIEF DESCRIPTION OF DRAWINGS

FIG. 1 is a vertical sectional view of a fuel injection valve of a first embodiment. (First Embodiment)

FIG. 2 is a perspective view of a retainer. (First Embodiment)

FIG. 3 is a perspective view for explaining rounding of the retainer. (First Embodiment)

FIG. 4 is a perspective view of a retainer of a second embodiment. (Second Embodiment)

### EXPLANATION OF REFERENCE NUMERALS AND SYMBOLS

2 Fixed core
10 Valve plunger
26A, 26B Retainer
27 Return spring
38 Opening
39 Tapered face
40 Cutout
41 Second cutout
42 Chamfered part
I Fuel injection valve

### MODES FOR CARRYING OUT THE INVENTION

Modes for carrying out the present invention are explained below by reference to the attached drawings.

### First Embodiment

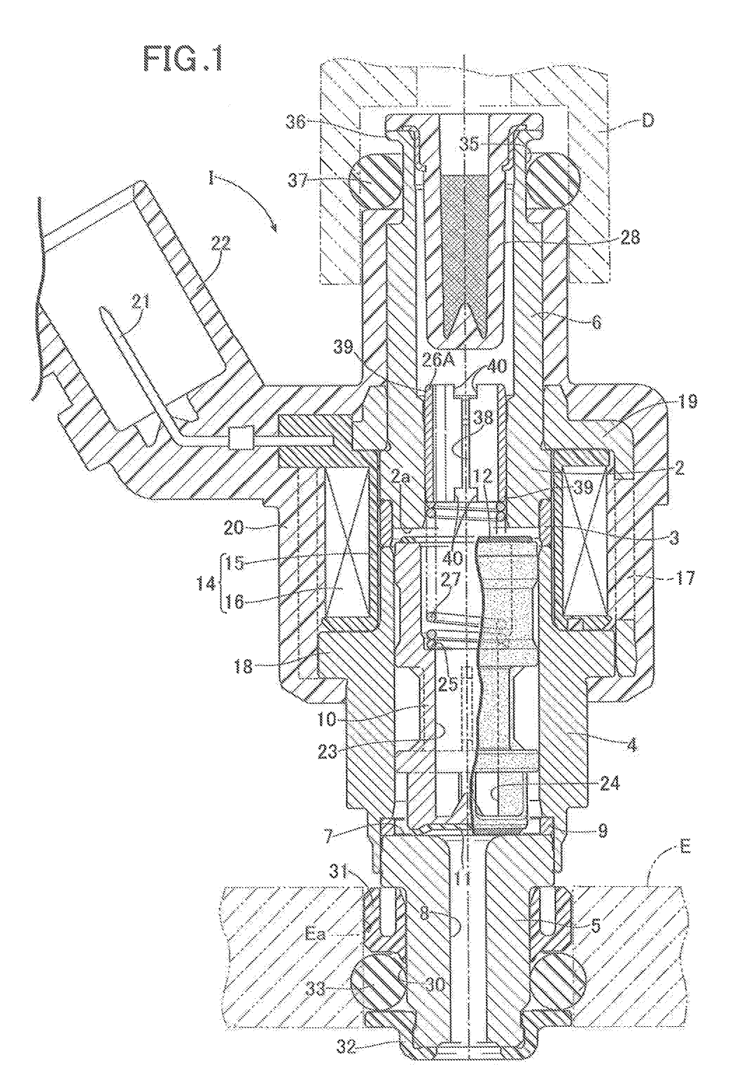

A first embodiment of the present invention is explained by reference to FIG. 1 to FIG. 3. First, in FIG. 1, this fuel injection valve I is for injecting gaseous fuel that is supplied to an engine; one end part of the fuel injection valve I is fitted into a mounting hole Ea provided in a tube wall of an intake tube E of the engine, and gaseous fuel is injected into the intake tube E from the fuel injection valve I during an intake stroke of the engine.

The fuel injection valve I includes a fixed core 2 that is formed into a cylindrical shape from a magnetic metal, a valve housing 4 that is formed into a hollow cylindrical shape from a magnetic metal and is provided so as to be connected to one end of the fixed core 2 via a non-magnetic cylindrical body 3, a cylindrical nozzle member 5 that is coaxially bonded to one end of the valve housing 4, a cylindrical fuel inlet tube 6 that has one end connectedly provided integrally with the other end of the fixed core 2, and a valve plunger 10 that is formed from a magnetic material and slidably fitted into the valve housing 4 so that it can move closer to or away from the fixed core 2.

The nozzle member 5 has a flat valve seat 7 facing the interior of the valve housing 4 and a nozzle hole 8 extending through a central part of the valve seat 7 and opening on one end face of the nozzle member 5, and an annular shim 9 for adjusting the position of the valve seat 7 is disposed between the nozzle member 5 and the valve housing 4.

The valve plunger 10 is slidably fitted into the valve housing 4 so as to oppose an attracting face 2a at said one end of the fixed core 2. Furthermore, a seating member 11, made of rubber, that can be seated on the valve seat 7 is joined by baking to one end of the valve plunger 10, and an annular cushion member 12, made of rubber, is joined by baking to the other end face of the valve plunger 10 so as to oppose the attracting face 2a. A predetermined gap is set between opposing faces of the cushion member 12 and the fixed core 2 when the seating member 11 is seated on the valve seat 7, the predetermined gap corresponding to a valve-opening stroke of the valve plunger 10.

A region extending from said one end part of the fixed core 2 to said other end part of the valve housing 4 is surrounded by a coil assembly 14; this coil assembly 14 is formed from a bobbin 15 fitted around the outer peripheries of the valve housing 4, the non-magnetic cylindrical body 3, and the fixed core 2, and a coil 16 wound around the outer periphery of the bobbin 15, and the coil assembly 14 is covered by a coil housing 17 formed from a magnetic metal.

A first yoke flange 18 is provided integrally with the valve housing 4, the first yoke flange 18 protruding radially outwardly from an intermediate part of the valve housing 4 so as to receive one end of the coil assembly 14. The first yoke flange 18 is fitted into one end part of the coil housing 17, and a second yoke flange 19 sandwiching the coil assembly 14 between itself and the first yoke flange 18 is integrally provided with the other end part the coil housing 17.

Furthermore, the fuel inlet tube 6, the coil housing 17 having the second yoke flange 19, and the first yoke flange 18 are covered by a continuously connected resin molded layer 20, and a coupler 22 protruding toward one side of the resin molded layer 20 is molded integrally therewith so as to retain an energization terminal 21 connected to the coil 16.

Provided in the valve plunger 10 are a bottomed lengthwise hole 23 having one end closed and the other end opening toward the fixed core 2, and a plurality of sideways holes 24 via which the lengthwise hole 23 opens on an outer peripheral face of one end part of the valve plunger 10, and an annular spring receiving step part 25 is provided on an intermediate part of the lengthwise hole 23 so as to face the fixed core 2 side.

On the other hand, a retainer 26A is press fitted into the fixed core 2, and a coil-shaped return spring 27 is provided between the retainer 26A and the spring receiving step part 25, the valve plunger 10 being urged by a spring force exhibited by the return spring 27 toward the side on which the seating member 11 at one end of the valve plunger 10 is seated on the valve seat 7. A fuel filter 28 is fitted into the fuel inlet tube 6, which communicates with the fixed core 2.

A pair of ring members 31 and 32, made of a synthetic resin, defining an annular first seal groove 30 are attached to the outer periphery of the nozzle member 5, and a front O ring 33 is fitted into the first seal groove 30, the front O ring 33 being in intimate contact with an inner peripheral face of the first seal groove 30 when the nozzle member 5 is inserted into the mounting hole Ea of the intake tube E.

An annular second seal groove 35 is defined on the outer periphery of the other end part of the fuel inlet tube 6 by means of the resin molded layer 20 and a flange 36 formed at the other end of the fuel inlet tube 6, and an O ring 37 is fitted into the second seal groove 35, the O ring 37 being in intimate contact with an inner peripheral face of a fuel distribution pipe D when the fuel distribution pipe D is fitted onto the outer periphery of the fuel inlet tube 6.

In such a fuel injection valve I, when the coil 16 is in a de-energized state, the seating member 11 on the valve plunger 10 is seated on the valve seat 7 by virtue of the urging force of the return spring 27. Gaseous fuel that has been fed to the fuel distribution pipe D in this state flows into the fuel inlet tube 6, is filtered through the fuel filter 28, passes from the interior of the retainer 26A through the lengthwise hole 23 and the sideways holes 24 of the valve plunger 10, and is held in readiness within the valve housing 4. In this process, the set load of the return spring 27 and the pressure of the gaseous fuel act on the valve plunger 10 as valve-closing forces, and the seating member 11 is thereby pressed toward the direction in which it is seated on the valve seat 7.

When the coil 16 is energized by passing an electric current, the magnetic flux generated thereby runs in sequence through the coil housing 17, the first yoke flange 18, the valve housing 4, the valve plunger 10, the fixed core 2, and the coil housing 17, the magnetic force makes the valve plunger 10 be attracted by the fixed core 2 against the set load of the return spring 27 to thus detach the seating member 11 from the valve seat 7, and the rubber cushion member 12 of the valve plunger 10 abuts against the attracting face 2a of the rubber fixed core 2, thereby restricting the limit of opening of the seating member 11 with respect to the valve seat 7.

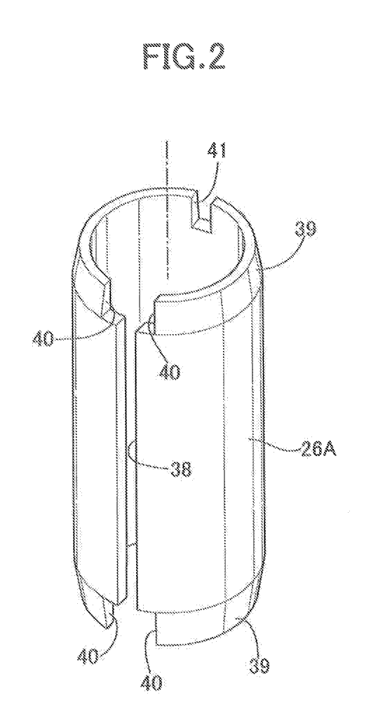

In FIG. 2, the retainer 26A is formed with a substantially C-shaped cross-section having one long straight opening 38 extending linearly along the entire length in the axial direction, tapered faces 39 and 39 being formed on the outer peripheries of opposite end parts in the axial direction of the retainer 26A.

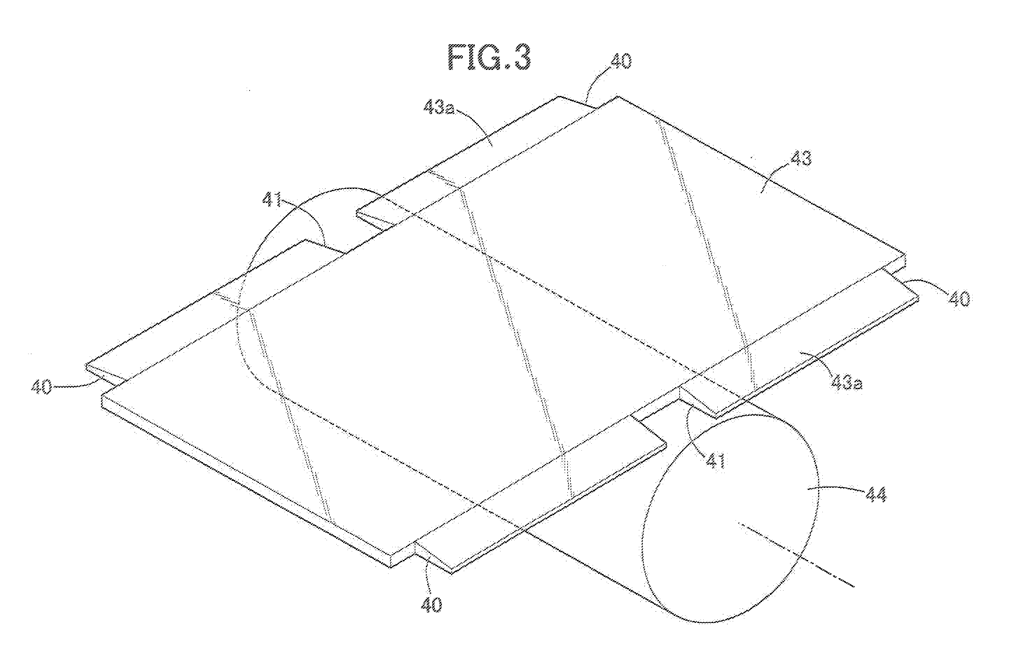

As shown in FIG. 3 the retainer 26A is formed by rounding by means of a cylindrical die 44 a flat plate-shaped material 43 having preformed inclined faces 43a and 43a in order to form the tapered faces 39 and 39. In this process, the material 44 has a region that is easily stretched and a region that is difficult to stretch, and the angle of the tapered faces 39 after rounding is sometimes non-uniform in the peripheral direction of the retainer 26A. In particular, warping easily occurs in peripherally opposite end parts sandwiching the opening 38 of the retainer 26A, and the tapered faces 39 and 39 in a middle part in the peripheral direction of the retainer 26A are susceptible to change in angle rounding.

If the retainer 26A is press fitted into the fixed core 2 with such warping or change in angle remaining, it might cause galling or swarf generation.

In accordance with the present invention, first cutouts 40 are provided in opposite end parts in the peripheral direction of the retainer 26A so as to increase the width between opposite end parts in the longitudinal direction of the opening 38, and second cutouts 41 and 41 are provided in sections, opposing the opposite end parts in the longitudinal direction of the opening 38, of a middle part in the peripheral direction of the retainer 26A.

The first cutouts 40 and the second cutouts 41 are preformed in the material 44 as shown in FIG. 3 when stamping the material 44 prior to rounding.

The operation of this first embodiment is now explained. Since the first cutouts 40 are provided in the opposite end parts in the peripheral direction of the retainer 26A so as to widen the opposite end parts in the longitudinal direction of the opening 38, the region in which warping easily occurs during rounding due to the presence of the opening 38 can be removed, thereby preventing the occurrence of galling or the generation of swarf when press fitting the retainer 26A into the fixed core 2. Moreover, since the structure merely involves providing the first cutouts 40, and the material for forming the retainer 26A is not limited, the degree of freedom in selecting the material can be ensured.

Furthermore, since the second cutouts 41 are provided in sections that oppose the opposite end parts in the longitudinal direction of the opening 38 in the middle part in the peripheral direction of the retainer 26A, although a change in angle of the tapered faces 39 in the middle part in the peripheral direction of the retainer 26A easily occurs during rounding, because the section in which the change in angle easily occurs is removed by the second cutouts 41, the angle of the tapered faces 39 can be made uniform in the peripheral direction, and this makes it unnecessary to carry out an operation of correcting the angle of the tapered faces 39, thus reducing the number of steps and reducing the cost while more reliably preventing the occurrence of galling or the generation of swarf when press fitting the fixed core retainer 26A into the fixed core 2.

### Second Embodiment

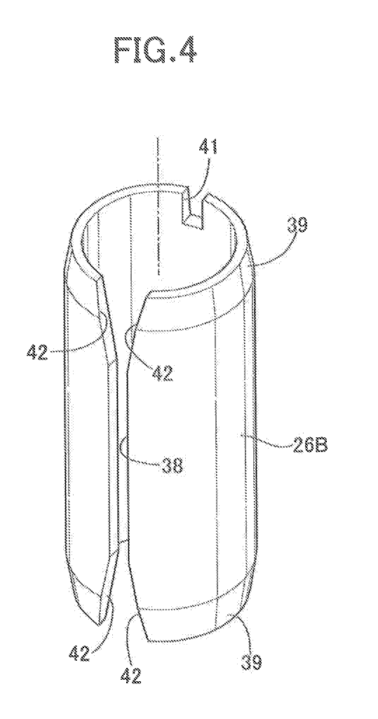

A second embodiment of the present invention is explained by reference to FIG. 4. Parts corresponding to those of the first embodiment in FIG. 1 to FIG. 3 are denoted by the same reference numerals and symbols and only illustrated, and a detailed explanation thereof is omitted.

Chamfered parts 42 are provided on opposite end parts in the peripheral direction of a retainer 26B formed with a substantially C-shaped cross-section having one long straight opening 38 extending linearly along the entire length in the axial direction and having tapered faces 39 and 39 on the outer peripheries of opposite end parts in the axial direction, the chamfered parts 42 being formed so as to increase the width of opposite end parts in the longitudinal direction of the opening 38, and cutouts 41 and 41 are provided in a middle part in the peripheral direction of the retainer 26B in sections opposing the opposite end parts in the longitudinal direction of the opening 38.

In accordance with this second embodiment also, the same effects as those of the first embodiment can be exhibited.

Embodiments of the present invention are explained above, but the present invention is not limited to the embodiments and may be modified in a variety of ways as long as the modifications do not depart from the spirit and scope thereof.

1. A fuel injection valve comprising:
a fixed core that is formed into a cylindrical shape from a magnetic metal,
a valve plunger that is coaxially disposed so as to oppose one end of the fixed core and which can move closer to or away from the fixed core,
a retainer that is configured with a substantially C-shaped cross-section, said retainer having one long straight opening extending linearly along an entire length thereof in an axial direction, said opening having a first width at an axially central portion thereof, the retainer further having a tapered face portion provided on an outer periphery of at least one of two axially end parts of the retainer, the tapered face portion extending to an axial tip end of the retainer, said retainer being press fitted into the fixed core, and
a coil-shaped return spring that is provided between the retainer and the valve plunger,
wherein one of a cutout and a chamfered part is provided in each of peripherally opposite circumferential end parts of the tapered face portion at the at least one of the two axially end parts of the retainer, so as to increase a width between the peripherally opposite circumferential end parts of the tapered face portion in a circumferential direction of the retainer, said width between the peripherally opposite circumferential end parts of the tapered face portion being greater than the first width.

2. The fuel injection valve according to claim 1, wherein a second cutout is provided in a middle part of the tapered face portion in the circumferential direction of the retainer in a section opposing the width between the peripherally opposite circumferential end parts of the tapered face portion.
